(19) United States
(12) Patent Application Publication
(10) Pub. No.: US 2026/0077606 A1
(43) Pub. Date: Mar. 19, 2026

(54) TRANSPORT DEVICE FOR SUBSTRATES, HAVING MOVABLE HOLD-DOWN DEVICES

(71) Applicant: Phoenix Contact GmbH & Co. KG, Blomberg (DE)

(72) Inventors: Jürgen GRETSCHER, Dornhan (DE); Erich MATZKOVITS, Villingen- Schwenningen (DE); Michael ESSLINGER, Rottweil (DE)

(21) Appl. No.: 19/135,418

(22) PCT Filed: Nov. 16, 2023
(86) PCT No.: PCT/EP2023/081989

§ 371 Date: Jun. 4, 2025

(30) Foreign Application Priority Data
Dec. 7, 2022 (DE) 10 2022 132 564
Mar. 6, 2023 (BE) BE2023/5163

(51) Int. Cl. B41J 11/00; B41J 3/407; B41J 13/10; B65G 49/06

(52) U.S. Cl. CPC B41J 11/0055; B41J 3/407; B41J 13/103; B65G 49/061

(57) ABSTRACT

A transport device for transporting substrates along at least one guide includes: a frame; and at least one hold-down device movable relative to the frame from a depositing position, in which a passage region is exposed, such that a substrate is depositable along a depositing direction through the passage region on the at least one guide, into a hold-down position, in which the at least one hold-down device is arranged in the passage region so as to block a movement of a deposited substrate on the at least one guide against the depositing direction.

### CROSS-REFERENCE TO PRIOR APPLICATIONS

This application is a U.S. National Phase application under 35 U.S.C. § 371 of International Application No. PCT/EP2023/081989, filed on Nov. 16, 2023, and claims benefit to German Patent Application No. 10 2022 132 564.4, filed on Dec. 7, 2022 and Belgian Patent Application No. BE2023/5163, filed on Mar. 6, 2023. The International Application was published in German on Jun. 13, 2024 as WO 2024/120781 A1 under PCT Article 21(2).

### FIELD

The invention relates to a transport device for transporting substrates, to a printing system having such a transport device, and to a method for transporting a substrate.

### BACKGROUND

Substrates which are to be processed, especially in the form of printing media for printing by a printer, are typically transported to the printer one after the other. There are various options for this.

WO 2020/174017 A1, for example, describes the transport of substrates in the form of marker cards to a printer by means of round belts.

However, such round belts typically have a relatively high elasticity. In addition, the round belt can slip relative to the drive rollers and the substrates can also slip relative to the round belt. As a result, such transport devices make it difficult to ensure accurate positioning of the substrates in the printer, which can limit print quality. These problems can be further aggravated by variations in the dimensions of the substrates due to manufacturing tolerances.

DE 10 2007 011 179 A1 describes a central guide in the middle of a substrate, wherein a transport pin attached to a support arm is inserted into a transport hole in the substrate in order to transport the substrate. The transport pin must be aligned with the transport hole with a relatively high degree of accuracy, which requires a complex structure and increases the risk of errors.

### SUMMARY

In an embodiment, the present invention provides a transport device for transporting substrates along at least one guide, comprising: a frame; and at least one hold-down device movable relative to the frame from a depositing position, in which a passage region is exposed, such that a substrate is depositable along a depositing direction through the passage region on the at least one guide, into a hold-down position, in which the at least one hold-down device is arranged in the passage region so as to block a movement of a deposited substrate on the at least one guide against the depositing direction.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a printing system for printing substrates in the form of printing media;

FIG. 2 is a view of a printing medium in the form of a label mat with multiple break-out identification labels;

FIGS. 3 to 6 are different views of parts of a transport device of the printing system according to FIG. 1;

FIG. 7A shows a concavely curved substrate;

FIG. 7B shows the concavely curved substrate according to FIG. 7A during insertion through an insertion bevel;

FIGS. 8 to 10 are various views of movable hold-down devices and a depositing device of the printing system according to FIG. 1; and

FIG. 11 is a detailed view of one of the hold-down devices of the printing system according to FIG. 1.

### DETAILED DESCRIPTION

In an embodiment, the present invention improves the transport of substrates in a simple manner.

Accordingly, a transport device for transporting substrates along at least one guide comprises a frame and at least one hold-down device which is movable relative to the frame from a depositing position into a hold-down position. In the depositing position of the at least one hold-down device, a passage region is exposed, such that a substrate can be deposited along a depositing direction through the passage region on the at least one guide. In the hold-down position, the at least one hold-down device is arranged in the passage region, such that a movement of the substrate deposited on the at least one guide against the depositing direction is blocked by the hold-down device.

This is based on the realization that substrates are not only subject to manufacturing tolerances in their exact dimensions, but can also be bent or twisted. If, for example, printable identification label mats are used as substrates, which were produced by injection molding, for example, then these identification label mats can be concavely curved. The hold-down devices of the proposed transport device can prevent a portion of an identification label mat being transported from lifting off the guide (or guides) during transport. This allows a particularly simple drive to be used. This makes it possible to design the transport device to be simple, robust and reliable while at the same time reducing the susceptibility to errors.

The at least one hold-down device can be mounted on the frame so as to be movable in a lateral direction perpendicular to the depositing direction, in particular translationally and/or rotationally, for example displaceably. This allows a particularly simple and robust guidance.

The at least one guide can define a transport direction which is oriented, for example, perpendicular to the lateral direction and/or perpendicular to the depositing direction. This makes a particularly simple construction possible because depositing, holding down and transporting take place in three independent directions.

Optionally, the transport device comprises two movable hold-down devices, in particular two hold-down devices movable in opposite directions relative to each other. In this way, a deposited substrate can be secured against lifting on two opposite sides (especially side edges), and thus particularly reliably.

The at least one hold-down device can (or the two hold-down devices can) be elongated and extend parallel to the at least one guide. This enables particularly secure blocking of the substrate from lifting off the guide.

Furthermore, the transport device can comprise a positioning device arranged next to the at least one hold-down device (e.g. directly adjacent to or at a distance from it), viewed in the direction of the at least one guide. The positioning device can serve to position a substrate mounted on the guides, in particular with at least one hold-down element fastened to the at least one guide. The hold-down devices of the transport device make possible a particularly reliable transfer of a substrate to the positioning device.

The at least one hold-down element of the positioning device attached to the guide can have an insertion bevel. This allows even curved or twisted substrates to be transported safely without jamming. The hold-down devices of the transport device can prevent a concave substrate that dips below the insertion bevel at the front from lifting so far at the rear that it becomes disengaged from a drive element (e.g. an arm of a pushing device).

The transport device can comprise a drive. The drive comprises, for example, a motor for driving a substrate deposited on the at least one guide along the at least one guide.

For example, the drive comprises a pushing device. The pushing device may be designed to push a substrate deposited on the guide(s), e.g. on a rear end face thereof. This enables a particularly reliable transport movement with a particularly simple construction. The at least one hold-down device of the transport device can prevent the substrate from lifting off the pushing device, even in the case of more strongly curved substrates.

Optionally, the transport device comprises a depositing device for depositing a substrate by means of at least one movable depositing element through the exposed passage region on the at least one guide. In this way, depositing and optionally also separating from a stack of substrates can be automated.

The movement of the at least one depositing element can be coupled to a movement of the at least one hold-down device. This means that both functions can be implemented with just one shared mechanism. This permits particularly simple and well-synchronized transport.

The at least one depositing element can be rotatably mounted. This permits continuous transport while retaining a simple construction.

Optionally, at least one depositing element is mounted in a rotationally fixed manner relative to a pusher, e.g. on the same shaft. The pusher can be arranged to act on an actuating surface of the hold-down device, for example to move the at least one hold-down device from the depositing position to the hold-down position (and/or vice versa).

At least one substrate in the form of a label mat, e.g. with multiple break-out identification labels, can be deposited on the guides. The substrate can be flat. Furthermore, the substrate can be rigid.

According to one aspect, a printing system is provided. The printing system comprises a printer for printing the substrates. Furthermore, the printing system comprises the transport device according to any embodiment described herein for transporting substrates to the printer (and optionally away from the printer). As regards the advantages, reference is made to the above statements regarding the transport device.

According to one aspect, a method for transporting a substrate with a transport device according to any embodiment described herein is provided. The method comprises the following steps: moving the at least one hold-down device into the depositing position; depositing a substrate through the passage region onto the at least one guide; moving the at least one hold-down device into the hold-down position; and displacing the substrate along the at least one guide. With regard to the advantages, reference is again made to the above information on the transport device.

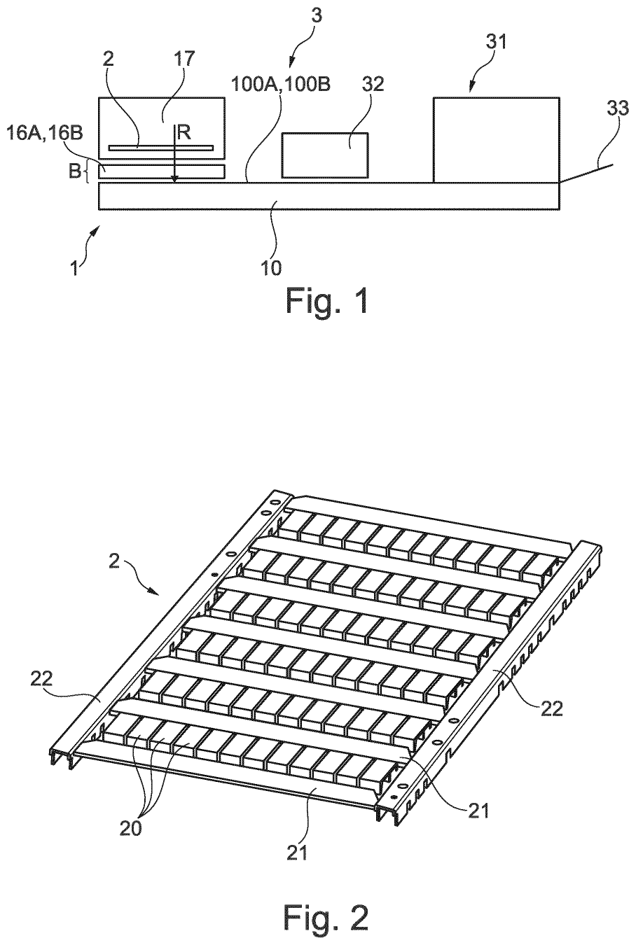

FIG. 1 shows a printing system 3 for printing on multiple individually-printable substrates in the form of printing media 2. For this purpose, the printing system 3 comprises a transport device 1 with a depositing device 17, e.g. in the form of a separating device, into which a printing medium or a stack of printing media 2 can be fed automatically or manually. The transport device 1 transports individual printing media 2 output from the depositing device 17 to a printer 32 of the printing system 3.

The printer 32 prints the individual printing media 2 one after the other. From the printer 32, the printing media 2 are transported to a stacking device 31 by means of the transport device 1. The stacking device 31 stacks the individually printed printing media 2 into a stack, which can then be removed manually or automatically from the stacking device 31. Alternatively, individual printing media 2 can be output to a separate output 33 by means of the transport device 1.

The transport device 1 comprises a frame 10 which has at least one guide 100A, 100B, as will be explained in more detail below. Furthermore, the transport device 1 comprises at least one hold-down device 16A, 16B which is movable relative to the frame 10 from a depositing position in which a passage region B is exposed—such that a printing medium 2 can be deposited along a depositing direction R through the passage region B on the at least one guide 100A, 100B—into a hold-down position in which the at least one hold-down device 16A, 16B is arranged in the passage region B, thereby blocking a movement of the substrate 2 deposited on the at least one guide 100A, 100B against the depositing direction R. As will be explained in more detail below, this makes a particularly simple and reliable transport of the substrates 2 possible.

FIG. 2 shows an example of such a printing medium 2. The printing medium 2 comprises a plurality of identification labels 20. The identification labels 20 are each formed on (at least) one of a plurality of webs 21. The webs 21 are arranged parallel to each other, with the identification labels 20 between two pairs of runners 22 serving as guides. The webs 21 are each fixed to the runners 22. The printing medium 2 is formed as a single piece. For example, it is an injection-molded part. In particular, the printing medium 2 can consist of a plastic or comprise a plastic. The individual identification labels 20 can be broken off from the webs 21. For example, an identification label 20 printed with the printer 32 can be attached to an electrical or electronic component in order to identify it. For this purpose, the identification labels 20 each have latch elements for latching to a corresponding component.

The printing medium 2 can also be called a mat or card. It is plate-shaped and rigid. Due to the weight of the printing medium 2, the printing medium 2 does not bend or only bends slightly, for example when it is held only on one side or corner.

The printing medium 2 has a length, a width and a height. The height is less than the length and width. The width is less than the length. The guides 22 extend along the length. The end faces of the printing medium 2 extend across its width.

Depending on the required shape and size of the identification labels 20, the printing medium 2 can have a greater or smaller number of identification labels 20 and webs 21 for holding the identification labels 20.

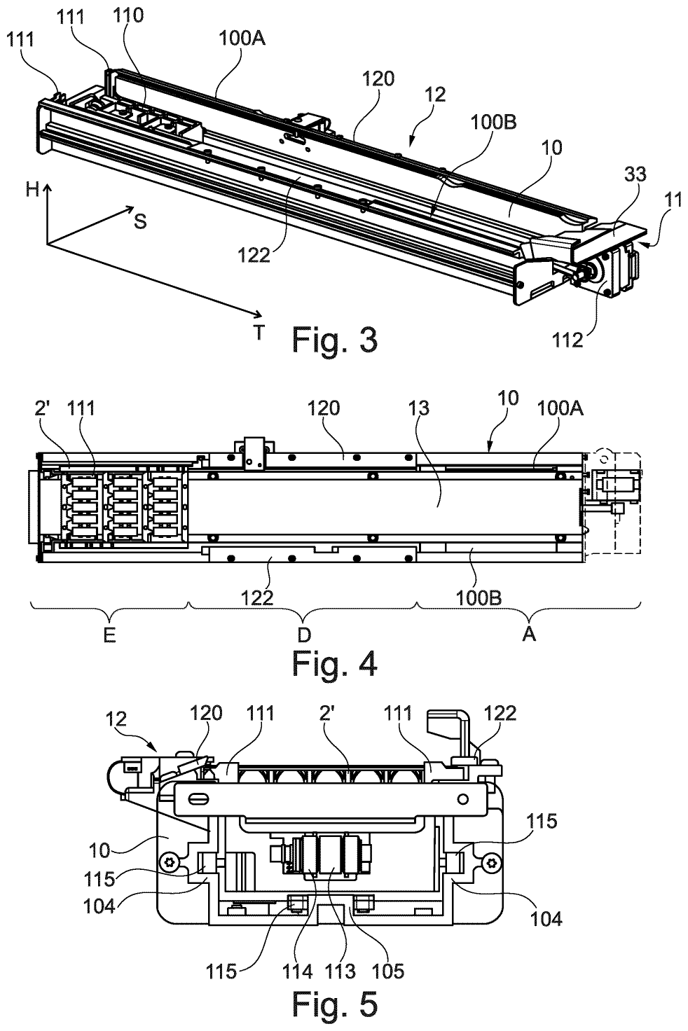

FIGS. 3 to 6 show parts of the transport device 1 and their mode of operation.

The transport device 1 comprises a drive 11 and a positioning device 12, which are mounted on the frame 10.

The frame 10 is formed as a single piece, in this case as an extruded profile. For example, the frame is made of aluminum or comprises aluminum. The frame 10 is elongated and has one long side. At different (optionally all) points along the long side, the frame 10 has the same cross-sectional shape. Extruded profiles can be made particularly stable and robust.

The transport device 1 has two guides 100A, 100B which extend longitudinally along a transport direction T and are spaced apart from one another in a lateral direction S perpendicular to the transport direction T. In general, the guides 100A, 100B may be fixed on or formed on the frame 10. In the example shown, the guides 100A, 100B are formed on the frame 10 and in this case constitute part of the frame 10.

The frame 10 comprises a base from which two lateral surfaces extend. The lateral surfaces are arranged parallel to each other. One guide 100A, 100B is formed at each open end of the lateral surfaces. The frame 10 therefore has a generally U-shaped cross-section. The frame 10 forms a trough.

Runners 22 of the printing medium 2′are guided on the guides 100A, 100B along the transport direction T.

The positioning device 12 has two hold-down elements 120, 122, each in the form of a hold-down plate. The hold-down elements 120, 122 are fixed to the frame 10. A hold-down element 120 runs obliquely to the guides 100A, 100B. As a result, the hold-down element 120 rests against the printing medium 2′ when the latter is located on the positioning device 12. The hold-down element 120 touches the printing medium 2′ at a curvature of an edge of the printing medium 2′, whereby a linear contact is present. This allows it to slide along without jamming, does not hinder the printing process, and allows precise positioning. Accordingly, a force is introduced obliquely, with one component along the height direction H downwards and one component along the lateral direction against the printing medium 2′.

The positioning device 12 thus serves to position the substrate 2′ mounted on the guides 100A, 100B in the lateral direction S, and in the vertical direction H perpendicular thereto.

An insertion bevel 121 of the hold-down element 120 allows safe insertion even of curved printing media 2′.

The hold-down element 120 is mounted directly on the frame 10, in this case screwed thereto, on an inclined mounting surface of the frame 10.

The positioning device 12 further comprises a hold-down element 122 arranged on the other guide 100B and aligned parallel to the lateral direction S. This hold-down element 122 thus extends in a plane which spans the transport direction T and the lateral direction S. It runs parallel to the flat guide surface of the guide 100B.

This hold-down element 122 also has an insertion bevel 123 for the printing medium 2′.

The positioning device 12 is arranged in a printing region D, as can be seen in particular from FIG. 4. In the assembled state, the printer 32 is arranged in the printing region D. The printing region D is located between an input area E and an output area A. In the input area E, printing media 2′ can be deposited on the guides 100A, 100B of the transport device 1 for printing. In the output area A, the printed printing media 2′ can be removed from the guides 100A, 100B of the transport device 1. This is done in the assembled state by means of the depositing device 17 and the stacking device 31.

The hold-down elements 120, 122 make it possible to print on the runners 22, and achieve a continuous, well-positioned guidance over the entire printing region D. This allows particularly good printing results.

By means of the drive 11, the printing medium 2′ mounted on the guides 100A, 100B can be moved along the guides 100A, 100B and thus in the transport direction T. The drive comprises a pushing device 110 which is displaceable relative to the frame 10. For this purpose, the frame 10 has multiple drive guides 104, 105. Two drive guides 104 are formed on the opposite lateral surfaces of the frame 10. Furthermore, a drive guide 105 is formed at the base of the frame 10. Sliders 115 of the pushing device 110 are guided on the drive guides 104, 105 along the transport direction T. Instead of (rotatably mounted) sliders 115, rotatable rollers can also be used as a means for translational movement guidance.

The drive 11 comprises a motor 112. The motor 112 in this case is fastened to a longitudinal end of the frame 10, specifically to an end plate 15 fastened to the end of the frame 10. The motor 112 drives a belt 113 extending along the transport direction T. The belt 113 is guided around a roller 114 which is rotatably mounted on an end plate 14. This end plate 14 is attached to the frame 10 at the end of the frame 10 opposite the motor 112. The pushing device 110 is, for example, attached to the belt 113 and can be moved along the transport direction T back and forth by activating the drive 11—consequently, in this case, by activating the motor 112.

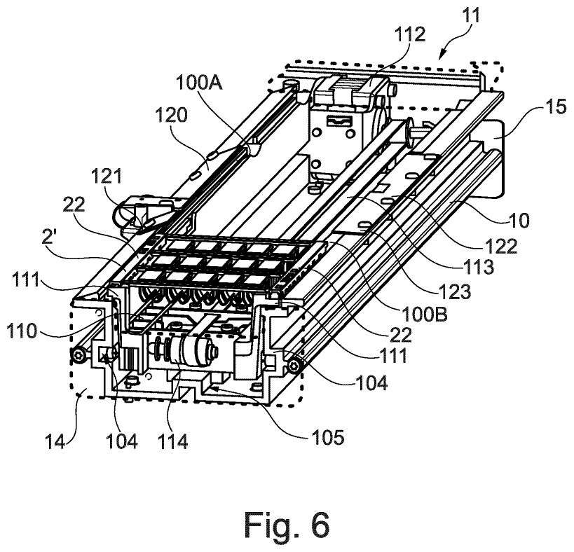

The pushing device 110 is designed to push the printing medium 2′ mounted on the guides 100A, 100B along the transport direction T. For this purpose, the pushing device 110 has at least one, in this case two, arms 111, which press against the printing medium 2′ when the motor 112 is activated (see e.g. FIG. 6). The arms 111 touch the printing medium 2′ at one corner each. As a result, the pushing device 110 acts on the lateral runners 22, preventing bending of the printing medium 2′ by the drive.

Rigid printing media can sometimes exhibit larger deviations from an ideal shape. For example, some or even all printing media may be concavely curved due to the manufacturing process.

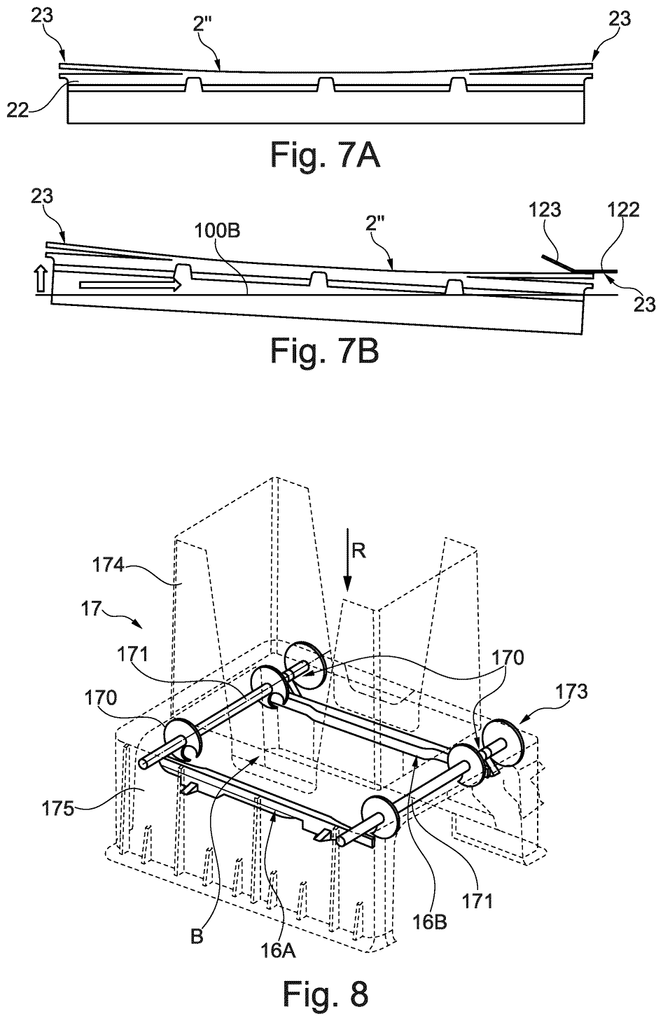

FIG. 7A shows such a concavely curved printing medium 2″ in the form of a simplified identification label mat. The printing medium 2″ has front and rear terminal edges 23 in the transport direction T. These terminal edges 23 are arranged on the front and rear end faces of the printing medium 2″. The terminal edges 23 are curved upwards, as can be seen in FIG. 7A. When the 2″ printing medium rests on the guides 100A, 100B with the side to be printed facing upwards, the terminal edges 23 will be curving upwards.

FIG. 7B illustrates what happens when the printing medium 2″ curved in this way is pushed under the hold-down elements 120, 122 by means of the insertion bevels 121, 123. As a result of the curvature of the printing medium 2″, the rear terminal edge 23 in the transport direction T lifts even more off the guides 100A, 100B. This may result in the engagement with the arms 111 of the pushing device 110 being lost. This could hinder transport and lead to jams.

In order to prevent this, the transport device 1 comprises the movable hold-down devices 16A, 16B already mentioned at the outset, the function of which will now be explained in more detail with reference to FIGS. 8 to 11.

The hold-down devices 16A, 16B are each elongated and aligned parallel to the transport direction T. The hold-down devices 16A, 16B are each as long as the passage region B, but could alternatively be longer or shorter. The hold-down devices 16A, 16B make up at least a large part of the length of the printing media 2″ that can be transported by the transport device 1. They are mounted displaceably relative to the frame 10, specifically displaceably mounted on a housing 175 of the depositing device 17, which is fastened to the frame 10. The two hold-down devices 16A, 16B can be moved in opposite directions to each other. Furthermore, the two hold-down devices 16A, 16B can be moved synchronously, i.e. towards each other at the same time or away from each other at the same time.

The depositing device 17 further comprises a guide 174, which in the example shown is formed by a part of the housing 175. A stack of printing media 2; 2′; 2″ can be inserted into the guide 174. In general, at least one depositing element 170, in this case four depositing elements 170, serve(s) to separate a printing element 2; 2′; 2″ from the stack and to deposit it on the guides 100A, 100B. For this purpose, the depositing elements 170 each have a recess. The depositing elements 170 are fixed to shafts 171. In the present case, two depositing elements 170 are fixed to the same shaft 171. The shafts 171 extend along the lateral direction S. The passage region B is located between the shafts 171 and the hold-down devices 16A, 16B. The depositing elements 170 are in the present case disc-shaped.

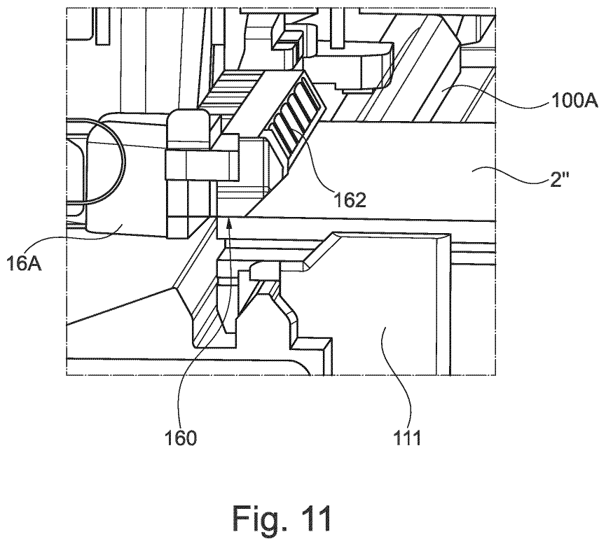

A drive 173 causes the two shafts 171 to rotate in opposite directions. As a result, with the recesses the depositing elements 170 grip the printing medium 2; 2′; 2″ which is positioned immediately above them and transport it vertically downwards in the depositing direction R. The hold-down devices 16A, 16B are brought into the depositing position, i.e. into a position further apart from each other compared to the hold-down position. This can be done, for example, by means of a spring-elastic preload or simply by the action of the downwardly conveyed printing medium 2; 2′; 2″. For this purpose, the hold-down devices 16A, 16B have upper bevels 162 (see in particular FIG. 11). The printing media 2; 2′; 2″, which are actively conveyed downwards by means of the depositing elements 170, slide along the upper bevels 162 and thus press the hold-down devices 16A, 16B outwards. The depositing direction R is parallel to the height direction H.

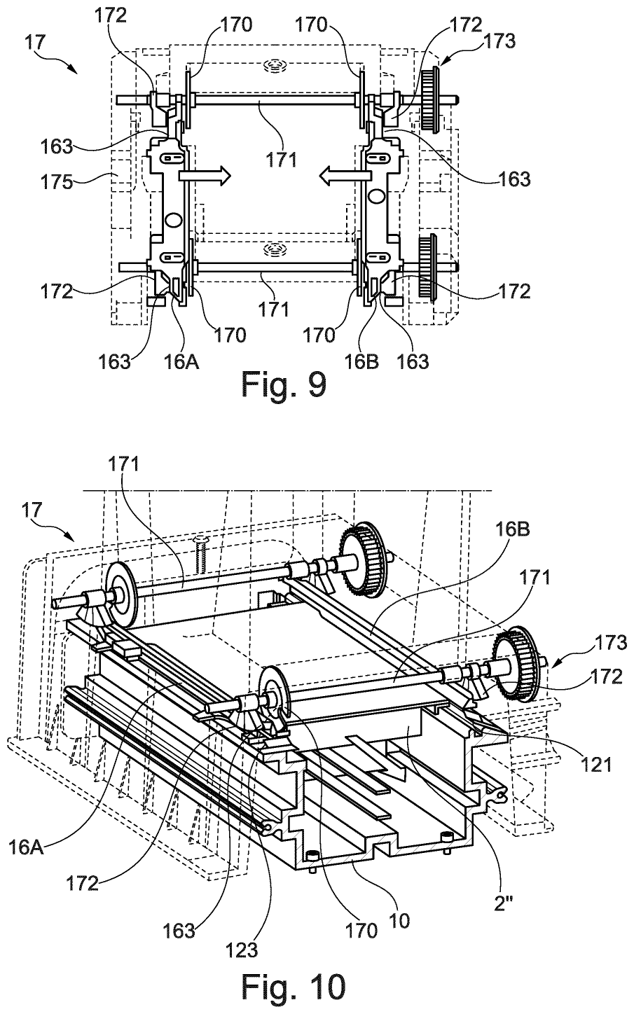

As soon as the currently conveyed printing medium 2; 2′; 2″ has been moved along the depositing direction R past the hold-down devices 16A, 16B, these are moved into the hold-down position, i.e. towards each other; see in particular the view obliquely from below according to FIG. 9. This can be done by spring-elastic preload or, as in the example shown, by means of pushers 172. The pushers 172 are fixed to the shafts 171 and rotate together with them. In the present case, one pusher 172 is mounted on each shaft 171 for each of the hold-down devices 16A, 16B. A total of four pushers 172 are provided. The pushers 172 each slide along an actuating surface 163 of the hold-down devices 16A, 16B. The actuating surfaces 163 each have a bevel. Thus, upon rotation, the pushers 172, together with the shafts 171, press the hold-down devices 16A, 16B into the hold-down position, as illustrated in FIG. 9. By fixing the pushers 172 and the depositing elements 170 to the shafts 171, this is coordinated with the depositing movement. As soon as the material has been deposited on the guides 100A, 100B, the hold-down devices 16A, 16B are moved into the hold-down position. The hold-down devices 16A, 16B each have guide contours for bolts attached to the housing 175.

FIG. 10 shows the printing medium 2″ with the hold-down devices 16A, 16B in the hold-down position (the two rear depositing elements 170 are not shown so as not to obscure the view of the parts behind them). Also visible are the insertion bevels 121, 123 of the hold-down elements 120, 122 fixed to the frame 10. Since the movable hold-down devices 16A, 16B hold the printing medium 2″ close to the guides 100A, 100B over its entire length, it does not lose contact with the arms 111 of the pushing device 110 even when it dips under the hold-down elements 120, 122 fixed to the frame 10.

FIG. 11 shows how the hold-down device 16A holds the printing medium 2″ against the guide 100A. A holding surface 160 of the hold-down device 16A faces the printing medium 2″ (more precisely: its upper side facing away from the guide 100A at an edge of the printing medium 2″). The edge of the printing medium 2″ is thus arranged between the hold-down device 16A and the guide 100A.

An optional cover 13 covers the belt 113 and parts of the pushing device 110 and thus protects them. The arms 111 of the pushing device 110 extend through lateral slots past the cover 13.

A method for transporting a substrate 2; 2′; 2″ with the transport device 1 comprises the following steps: moving the at least one hold-down device 16A, 16B into the depositing position; depositing a substrate 2; 2′; 2″ through the passage region B on the at least one guide 100A, 100B; moving the at least one hold-down device 16A, 16B into the hold-down position; and displacing the substrate 2; 2′; 2″ along the at least one guide 100A, 100B.

The described transport device 1 makes it possible to compensate for the manufacturing tolerances of the printing media 2; 2′, as early as when they are deposited on the guides 100A, 100B of the transport device 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Transport device
10 Frame
100A, 100B Guide
104, 105 Drive guide
11 Drive
110 Pushing device
111 Arm
112 Motor
113 Belt
114 Roller
115 Slider
12 Positioning device
120 Hold-down element
121 Insertion bevel
122 Hold-down element
123 Insertion bevel
13 Cover
14, 15 End plate
16A, 16B Hold-down device
160 Holding surface
162 Bevel
163 Actuating surface
17 Depositing device
170 Depositing element
171 Shaft
172 Pusher
173 Drive
174 Guide
175 Housing
2, 2′, 2″ Printing medium (substrate)
20 Identification label
21 Ridge
22 Runner
23 Terminal edge
3 Printing system
31 Stacking device
32 Printer
33 Output
A Output area
B Passage region
D Printing region
E Input area
H Height direction
R Depositing direction
S Lateral direction
T Transport direction

1. A transport device for transporting substrates along at least one guide, comprising:
a frame; and
at least one hold-down device movable relative to the frame from a depositing position, in which a passage region is exposed, such that a substrate is depositable along a depositing direction through the passage region on the at least one guide, into a hold-down position, in which the at least one hold-down device is arranged in the passage region so as to block a movement of a deposited substrate on the at least one guide against the depositing direction.

2. The transport device of claim 1, wherein the at least one hold-down device is mounted relative to the frame so as to be displaceable in a lateral direction perpendicular to the depositing direction.

3. The transport device of claim 2, wherein the at least one guide defines a transport direction which is oriented perpendicular to the lateral direction and perpendicular to the depositing direction.

4. The transport device of claim 1, wherein the at least one hold-down device comprises two hold-down devices movable relative to each other in opposite directions.

5. The transport device of claim 1, wherein the at least one hold-down device extends parallel to the at least one guide.

6. The transport device of claim 1, further comprising:
a positioning device arranged along the at least one guide next to the at least one hold-down device, the positioning device being configured to position a substrate mounted on the at least one guide with at least one hold-down element fastened to the at least one guide.

7. The transport device of claim 6, wherein the at least one hold-down element of the positioning device has an insertion bevel.

8. The transport device of claim 1, further comprising:
a drive with a motor configured to drive the deposited substrate on the at least one guide along the at least one guide.

9. The transport device of claim 8, wherein the drive comprises a pushing device configured to push the deposited substrate on the guides.

10. The transport device of claim 1, further comprising:
a depositing device configured to deposit the substrate by at least one movable depositing element through the exposed passage region on the at least one guide.

11. The transport device of claim 10, wherein a movement of the at least one depositing element is coupled to a movement of the at least one hold-down device.

12. The transport device of claim 10, wherein the at least one depositing element is rotatably mounted.

13. The transport device of claim 12, wherein the at least one depositing element is mounted in a rotationally fixed manner relative to a pusher, which is configured to act on an actuating surface of the at least one hold-down device so as to move the at least one hold-down device from the depositing position into the hold-down position.

14. The transport device of claim 1, wherein at least one substrate comprises an identification label mat with multiple break-out identification signs, the identification label mat being deposited on the at least one guide.

15. A printing system, comprising:
a printer; and
the transport device of claim 1, the transport device being configured to transport substrates to the printer.

16. A method for transporting a substrate with the transport device of claim 1, the method comprising:
moving the at least one hold-down device into the depositing position;
depositing the substrate through the passage region on the at least one guide;
moving the at least one hold-down device into the hold-down position; and
moving the substrate along the at least one guide.
